(19) United States
(12) Patent Application Publication
(10) Pub. No.: US 2020/0223379 A1
(43) Pub. Date: Jul. 16, 2020

(54) WIRE HARNESS FOR SEAT

(71) Applicant: Yazaki Corporation, Tokyo (JP)

(72) Inventor: Tomoyoshi KIKKAWA, Shizuoka (JP)

(21) Appl. No.: 16/711,375

(22) Filed: Dec. 11, 2019

(30) Foreign Application Priority Data
Jan. 10, 2019 (JP) 2019-002401

(51) Int. Cl. B60R 16/027; B60N 2/14; B60N 2/06; B60R 16/037

(52) U.S. Cl. CPC B60R 16/027; B60R 16/037; B60N 2/06; B60N 2/14

(57) ABSTRACT

A wire harness for a seat includes a first routing member, a winding unit, and a second routing member. The first routing member is connected with a power source on a vehicle floor side. The winding unit includes a stator and a rotor. The stator is slidable but non-rotatable with a seat and is connected with the first routing member to thereby unwind and wind the first routing member as the seat slides. The rotor is slidable and rotatable with the seat. The second routing member is disposed in the seat and has a first end portion connected with the rotor and a second end portion connected with an electric component disposed in the seat.

### CROSS-REFERENCE TO RELATED APPLICATION(S)

The present application claims priority to and incorporates by reference the entire contents of Japanese Patent Application No. 2019-002401 filed in Japan on Jan. 10, 2019.

### BACKGROUND OF THE INVENTION

### 1. Field of the Invention

The present invention relates to a wire harness for a seat.

### 2. Description of the Related Art

Japanese Patent Application Laid-open No. 2013-023069, for example, discloses, as a wire harness for a seat applicable to a vehicle, a power feeding apparatus for a sliding seat. The power feeding apparatus for a sliding seat feeds electricity by electrically connecting a side of a vehicle body of the vehicle with a side of a sliding seat that is slidable in a predetermined direction with respect to the vehicle body.

A need exists in the power feeding apparatus applicable to a sliding seat disclosed in Japanese Patent Application Laid-open No. 2013-023069 for a configuration that enables, for example, even more various seat arrangements.

### SUMMARY OF THE INVENTION

The present invention has been made in view of the foregoing situation and it is an object of the present invention to provide a wire harness for a seat, capable of properly feeding electricity to the seat.

A wire harness for a seat according to one aspect of the present invention includes a first routing member that has a first end portion connected electrically with a power source on a side of a vehicle floor; a winding unit disposed at a rotational shaft of a seat disposed on the vehicle floor, the winding unit including a stator and a rotor, the stator being capable of sliding with the seat in a sliding direction and incapable of rotating integrally with the seat in a rotating direction about the rotational shaft of the seat and the stator being connected with a second end portion of the first routing member to thereby unwind and wind the first routing member as the seat slides, the rotor being capable of sliding with the seat in the sliding direction and capable of rotating integrally with the seat in the rotating direction about the rotational shaft; and a second routing member disposed in the seat, the second routing member having a first end portion connected with the rotor and a second end portion connected electrically with an electric component disposed in the seat, wherein the rotor rotates relatively to the stator with rotation of the seat and relays an electric connection between the first routing member connected with the stator and the second routing member connected with the rotor.

According to another aspect of the present invention, in the wire harness for a seat, the stator may unwind and wind the first routing member in the sliding direction with sliding motion of the seat.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side elevation view of a schematic configuration of a seat to which a wire harness for a seat according to an embodiment is applied;

FIG. 2 is a plan view of the schematic configuration of the seat to which the wire harness for a seat according to the embodiment is applied;

FIG. 3 is a perspective view of the schematic configuration of the seat to which the wire harness for a seat according to the embodiment is applied;

FIG. 4 is a perspective view of a schematic configuration of a winding unit included in the wire harness for a seat according to the embodiment;

FIG. 5 is a cross-sectional perspective view of the schematic configuration of the winding unit included in the wire harness for a seat according to the embodiment;

FIG. 6 is a schematic perspective view of an operation example of the seat to which the wire harness for a seat according to the embodiment; and

FIG. 7 is a schematic plan view of an operation example of the seat to which the wire harness for a seat according to the embodiment is applied.

### DETAILED DESCRIPTION OF THE PREFERRED EMBODIMENTS

The following details, with reference to the accompanying drawings, an embodiment according to the invention. The embodiment is not to be considered limiting. The elements in the following embodiment include those that can be replaced and easily conceived by those skilled in the art and those that are substantially identical to each other.

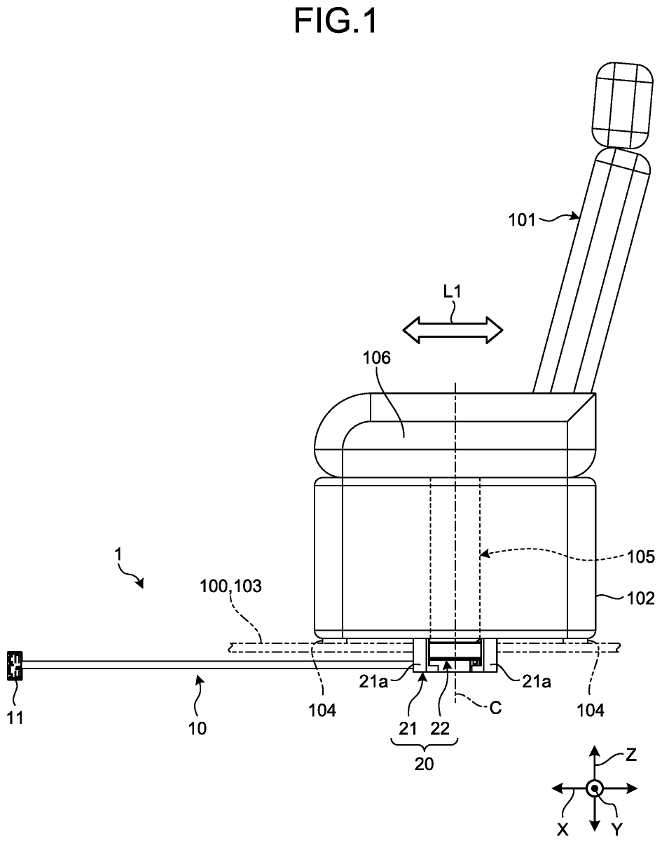

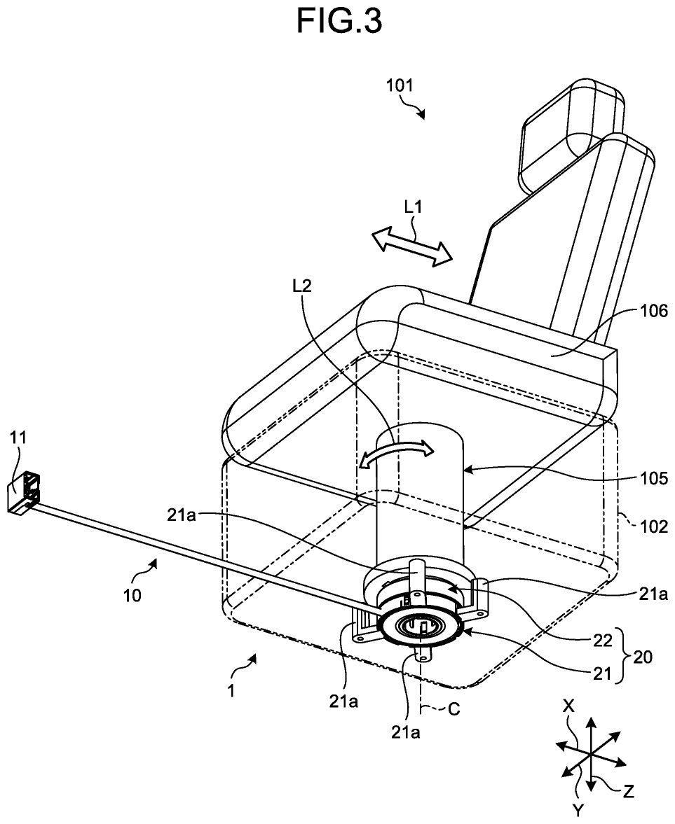

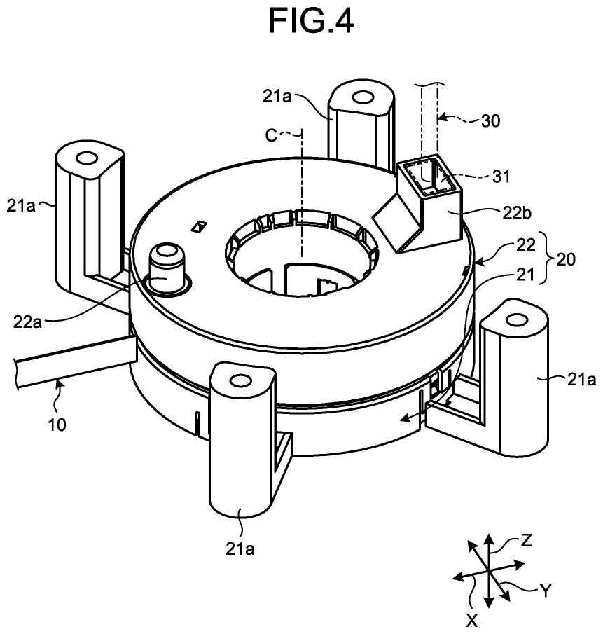

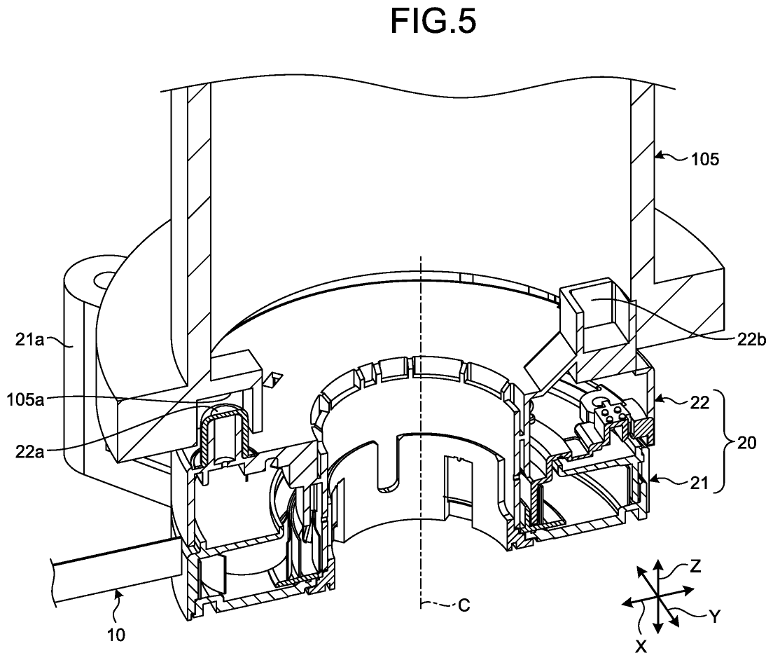

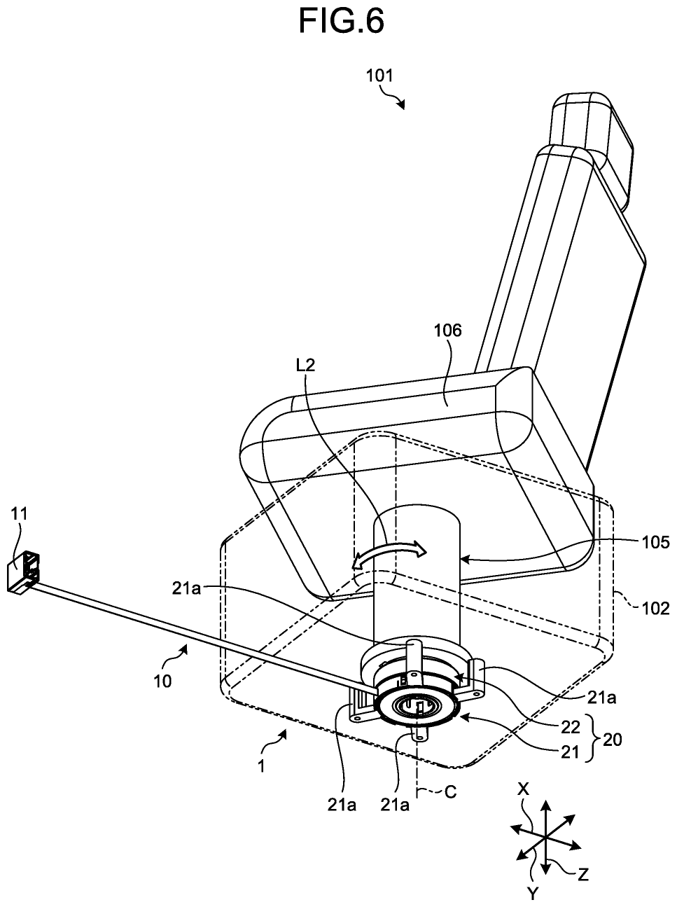

FIGS. 1, 2, and 7 each illustrate only a part of a vehicle floor with a dash-double-dot line, while the rest of the drawings omit illustrating the vehicle floor. FIGS. 3 and 6 each illustrate a seat base with a dash-double-dot line, while FIGS. 4 and 5 omit illustrating the seat base. FIGS. 1, 2, and 7 each illustrate only a part of a seat rail with a dash-double-dot line, while the rest of the drawings omit illustrating the seat rail. Additionally, each of the drawings omits illustrating portions of the seat other than major components as appropriate. In the descriptions given hereunder, of a first direction, a second direction, and a third direction that are orthogonal to each other, the first direction is referred to as a “fore-aft direction X”, the second direction is referred to as a “width direction Y”, and the third direction is referred to as a “height direction Z”. The fore-aft direction X, the width direction Y, and the height direction Z are orthogonal to each other. Typically, under a condition in which a wire harness for a seat is mounted on a vehicle and the vehicle is located on a horizontal surface, the fore-aft direction X and the width direction Y extend in a horizontal direction and the height direction Z extends in a vertical direction. The fore-aft direction X typically corresponds to an overall length direction of the vehicle in which the wire harness for a seat is mounted and corresponds in the embodiment to a direction extending along a sliding direction of the seat. The width direction Y typically corresponds to an overall width direction of the vehicle in which the wire harness for a seat is mounted. The height direction Z typically corresponds to a height direction of the vehicle in which the wire harness for a seat is mounted. Unless otherwise noted, each of the directions to be used in the following descriptions denotes a direction under a condition in which different components are assembled together.

Embodiment

A wire harness for a seat 1 in the embodiment, which is illustrated in FIGS. 1, 2, and 3, constitutes a part of an in-vehicle power feeding system. The in-vehicle power feeding system feeds (supplies) electricity to a seat 101. The seat 101 is disposed on a vehicle floor 100. The vehicle floor 100 constitutes a floor surface of the vehicle.

The seat 101 provides a place in which an occupant of the vehicle is seated. The seat 101 is disposed so as to be slidable in a sliding direction L1 with respect to the vehicle floor 100. The sliding direction L1 of the seat 101 in the embodiment extends in a direction extending in the fore-aft direction X. The seat 101 is supported on a seat rail 103 via a seat base 102. The seat rail 103 is disposed on the vehicle floor 100. The seat base 102 serves as a pedestal that is disposed on a lower side in the height direction Z of the seat 101 and that supports the seat 101. A plurality of sliders 104 are disposed on a lower side surface in the height direction Z of the seat base 102. The seat rail 103 serves as a guide rail for guiding sliding motion of the seat 101 in the fore-aft direction X. The seat rail 103 is disposed on the vehicle floor 100 so as to extend in the fore-aft direction X. The seat rail 103 is provided in pairs. The seat rails 103 are spaced apart from each other in the width direction Y. The sliders 104 fit in each of the seat rails 103 and each of the seat rails 103 guide the sliders 104 in the sliding direction L1 (fore-aft direction X). The foregoing configurations result in the seat 101 being supported on the seat base 102 and each of the seat rails 103 via the sliders 104 and being slidable along each of the seat rails 103 in the sliding direction L1. The seat 101 may be configured to be slidable electrically or manually.

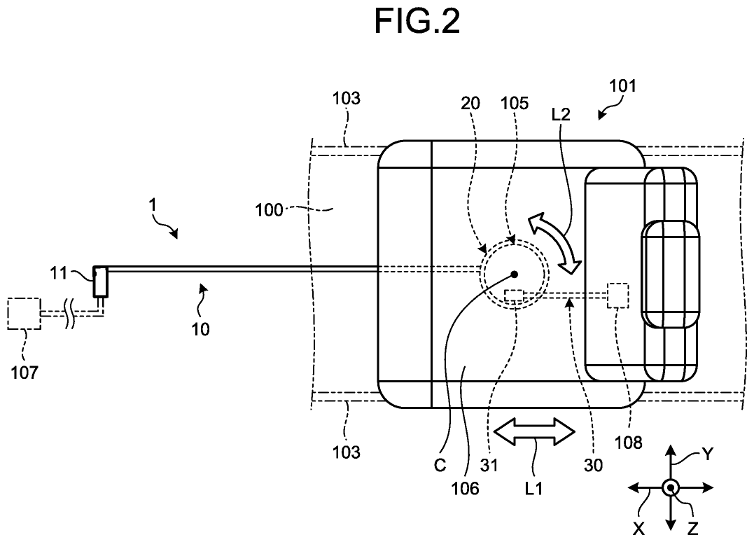

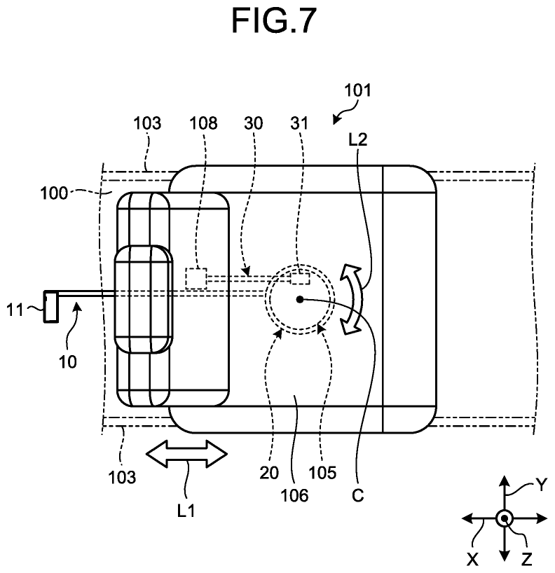

The seat 101 in the embodiment includes a rotational shaft 105 and is rotatable in a rotating direction L2 about the rotational shaft 105. The rotational shaft 105 is disposed in a seat cushion portion 106, in which the occupant is seated, in the seat 101. The rotational shaft 105 is formed to protrude from a lower side surface in the height direction Z of the seat cushion portion 106 toward the lower side in the height direction Z. The rotational shaft 105 is formed substantially into a cylinder having a central axis C extending in the height direction Z. The rotational shaft 105 is supported by the seat base 102 rotatably about the central axis C. Through the foregoing configurations, the seat 101 is configured to be rotatable through any angle in the rotating direction L2 about the central axis C of the rotational shaft 105. The seat base 102, in contrast, is fixed unrotatably in the rotating direction L2 about the central axis C of the rotational shaft 105 under a condition in which the seat base 102 is supported on each of the seat rails 103 via the sliders 104. The seat 101 illustrated in FIG. 7, for example, represents a seat 101 rotated through 180 degrees with respect to a reference position illustrated in FIG. 2. The seat 101 may be configured to be rotatable electrically or manually.

The wire harness for a seat 1 feeds electricity to the seat 101, which is disposed on the vehicle floor 100 slidably in the sliding direction L1 and rotatably in the rotating direction L2 as described above.

More specifically, the wire harness for a seat 1 includes a first routing member 10, a winding unit 20, and a second routing member 30.

The first routing member 10 is electrically conductive and constitutes a part of an electricity feed line that connects a power source 107 on a side of the vehicle floor 100 with an electric component 108, which is disposed in the seat 101. The power source 107 is mounted in the vehicle and serves as a source of electricity supply. The power source 107 includes, for example, an electricity generating device that generates electricity and an electricity storage device that stores electricity. The power source 107 is mounted on the side of the vehicle floor 100 and is not moved with the seat 101. The electric component 108 is an electronic device that operates on electricity supplied from the power source 107. Examples of the electric component 108 include, but are not limited to, various types of actuators, such as a heater heating the seat cushion portion 106 and an electric motor driving different parts, various types of sensors that detect, for example, a load, and various types of switches that receive an operating input. The electric component 108 is disposed at the seat 101 and movable with the seat 101. A positional relation between the power source 107 and the electric component 108 is such that the electric component 108 is relatively moved with respect to the power source 107 with the sliding motion or rotation of the seat 101. The electricity feed line including the first routing member 10 supplies electricity between the power source 107 and the electric component 108.

The first routing member 10 is routed in a space on a lower side in the height direction Z of the vehicle floor 100 (specifically, under the floor). The first routing member 10 is, for example, an electric wire that represents a plurality of electrically conductive conductors (core wires) covered in an insulative covering. The first routing member 10 includes, for example, a flat cable (flexible flat cable (FFC)) that is formed into a long flat band shape. The first routing member 10 extends in the fore-aft direction X. The first routing member 10 has a side on a first end portion in the fore-aft direction X connected electrically with the power source 107. A connector 11 is disposed on the first end portion in the fore-aft direction X and the first routing member 10 is electrically connected with the power source 107 via the connector 11 and another routing member. The connector 11 is mounted on the side of the vehicle floor 100, so that the first end portion in the fore-aft direction X of the first routing member 10 is not moved with the seat 101. The first routing member 10 has a side on a second end portion in the fore-aft direction X connected with the winding unit 20 and the second end portion of the first routing member 10 is movable with the seat 101.

The winding unit 20 takes up an excess length of the first routing member 10 as the seat 101 slides or rotates and permits rotation of the seat 101. The winding unit 20 in the embodiment includes a stator 21 and a rotor 22 and is disposed at the rotational shaft 105 of the seat 101. The winding unit 20 is disposed, in the embodiment, on an end face on the lower side in the height direction Z of the rotational shaft 105.

More specifically, the stator 21 serves a function in the winding unit 20 of mainly taking up an excess length of the first routing member 10 as the seat 101 slides. As illustrated in FIGS. 1, 3, and 4, the stator 21 is formed substantially into a cylinder having an axis coaxial with the central axis C of the rotational shaft 105. The stator 21 includes a plurality of (in the embodiment, four) bracket portions 21a. The stator 21 is spaced apart from the end face on the lower side in the height direction Z of the rotational shaft 105 and is fixed to a surface of the seat base 102 on the lower side in the height direction Z via the bracket portions 21a. Through the foregoing configurations, the stator 21 is fixed so as to be capable of sliding in the sliding direction L1 with the seat 101 and incapable of rotating integrally with the seat 101 in the rotating direction L2 about the rotational shaft 105.

The stator 21 is connected with the second end portion in the fore-aft direction X of the first routing member 10. The stator 21 thereby unwinds and winds the side of the second end portion of the first routing member 10 as the seat 101 slides. The stator 21 unwinds and winds the first routing member 10 in synchronism with the sliding motion of the seat 101. The first routing member 10 functions as what is called a spiral cable by being unwound and wound by the stator 21. The stator 21 is formed with various types of well-known structures including a return spring that exerts an urging force toward a winding side on the first routing member 10, which has been unwound from the stator 21.

The rotor 22 serves a function in the winding unit 20 of mainly permitting rotation of the seat 101 by maintaining a condition in which the first routing member 10 is electrically connected with the second routing member 30. The rotor 22 is formed, as illustrated in FIGS. 1, 3, and 4, substantially into a cylinder having an axis coaxial with the central axis C of the rotational shaft 105, as with the stator 21. As illustrated in FIGS. 4 and 5, the rotor 22 includes a boss portion 22a and a connector connection portion 22b. The boss portion 22a and the connector connection portion 22b are formed on a surface of the rotor 22 on the upper side in the height direction Z.

The boss portion 22a protrudes in the height direction Z from the surface of the rotor 22 on the upper side in the height direction Z and is formed substantially into a cylinder. The boss portion 22a is formed at a position offset from the central axis C. The rotor 22 is held in the height direction Z between the end face on the lower side of the rotational shaft 105 and the stator 21. Under the foregoing condition, the boss portion 22a is fitted in a fitting recessed portion 105a, which is formed in the end face on the lower side of the rotational shaft 105. Through the foregoing configurations, the rotor 22 is configured so as to be capable of sliding in the sliding direction L1 with the seat 101 and capable of rotating integrally with the seat 101 in the rotating direction L2 about the rotational shaft 105. Additionally, the rotor 22 is configured so as to rotate relatively to the stator 21 as the seat 101 rotates.

The connector connection portion 22b protrudes from a surface on the upper side of the rotor 22 in the height direction Z and is formed substantially into a rectangular tubular form. The connector connection portion 22b is formed at a position on the opposite side of the central axis C from the boss portion 22a with respect to a direction orthogonal to the central axis C. The connector connection portion 22b is formed at a position facing inside the rotational shaft 105 under a condition in which the rotor 22 is held between the end face on the lower side of the rotational shaft 105 and the stator 21. The second routing member 30 has a connector 31 connected with the connector connection portion 22b.

The second routing member 30 is electrically conductive and constitutes a part of an electricity feed line that connects the power source 107 on the side of the vehicle floor 100 with the electric component 108, which is disposed in the seat 101. The second routing member 30 is disposed in, and routed within, the seat 101. As with the first routing member 10, the second routing member 30 is, for example, an electric wire that represents a plurality of electrically conductive conductors (core wires) covered in an insulative covering. In the embodiment, the second routing member 30 may be formed from a flat cable (FFC) as with the first routing member 10, or from an ordinary electric wire. The second routing member 30 has a first end portion connected with the rotor 22 of the winding unit 20. In the embodiment, the connector 31 is disposed at the first end portion of the second routing member 30 and is connected with the connector connection portion 22b of the rotor 22. The foregoing arrangement connects the second routing member 30 with the rotor 22. The second routing member 30 has a second end portion connected electrically with the electric component 108, which is disposed in the seat 101. The second routing member 30 has an excess length invariable regardless of the sliding motion or rotation of the seat 101.

The rotor 22, while rotating relatively to the stator 21 with the rotation of the seat 101 as described above, constitutes a rotary connector that relays an electric connection between the first routing member 10, which is connected with the stator 21, and the second routing member 30, which is connected with the rotor 22. To state the foregoing differently, the rotor 22 permits, with the rotation of the seat 101, rotation of the stator 21, with which the first routing member 10 is connected, relative to the connector 31 of the second routing member 30, which is connected with the rotor 22. The rotor 22 additionally relays electric conduction via, for example, a conductive member disposed thereinside, between the first routing member 10 on the side of the vehicle floor 100 and the second routing member 30 on the side of the seat 101.

The rotor 22 of the winding unit 20, which is configured as described above, maintains an electric connection between the first routing member 10 on the side of the vehicle floor 100 and the second routing member 30 on the side of the seat 101, while permitting rotation of the seat 101 in the rotating direction L2 relative to the stator 21 with the rotation of the seat 101. Specifically, when the seat 101 is rotated from a predetermined reference position (see, for example, FIGS. 2 and 3) in a first direction in the rotating direction L2 (see, for example, FIGS. 6 and 7), the rotor 22 maintains the electric connection between the first routing member 10, which is connected with the stator 21, and the second routing member 30, which is connected with the rotor 22, while rotating relative to the stator 21. The rotor 22 operates similarly when the seat 101 is rotated so as to return to the reference position (see, for example, FIGS. 2 and 3) from a position reached through the rotation in the first direction in the rotating direction L2 (see, for example, FIGS. 6 and 7).

The stator 21 of the winding unit 20 unwinds and winds the first routing member 10 in the sliding direction L1 with the sliding motion of the seat 101. Specifically, when the seat 101 is slid in the sliding direction L1 (fore-aft direction X) toward a side on which the seat 101 approaches the connector 11 (for example, the seat 101 is moved from the position illustrated in FIG. 2 or 3 to the position illustrated in FIG. 7), the stator 21 winds the first routing member 10 in the sliding direction L1. When the seat 101 is slid in the sliding direction L1 (fore-aft direction X) toward a side on which the seat 101 is spaced away from the connector 11 (for example, the seat 101 is moved from the position illustrated in FIG. 7 to the position illustrated in FIG. 2 or 3), the winding unit 20 unwinds the first routing member 10 in the sliding direction L1.

It is noted that a combination of the electric component 108 and the second routing member 30, which is connected with the connector connection portion 22b of the rotor 22, is not limited to one set, but may be a plurality of sets. Specifically, a plurality of second routing members 30 may be connected with the rotor 22. In this case, the rotor 22 of the winding unit 20 may serve also as a power distribution device that distributes electricity to a plurality of electric components 108 via the second routing members 30.

The wire harness for a seat 1, which has been described above, electrically connects the power source 107 on the side of the vehicle floor 100 with the electric component 108 in the seat 101 via the first routing member 10, the winding unit 20, and the second routing member 30 to thereby be able to feed electricity from the power source 107 to the electric component 108. In this case, the winding unit 20 causes the stator 21 to unwind and wind the first routing member 10 with the sliding motion of the seat 101. Through the foregoing configurations, the winding unit 20 can properly take up an excess length of the first routing member 10 under a condition in which tension acts on the first routing member 10 corresponding to a sliding position of the seat 101. The winding unit 20 also relays an electric connection between the first routing member 10 and the second routing member 30 through the rotor 22, which rotates relatively to the stator 21 with the rotation of the seat 101. Through the foregoing configurations, the winding unit 20 can permit rotation of the seat 101 while maintaining a condition in which the first routing member 10 is electrically connected with the second routing member 30. As a result, the wire harness for a seat 1 can properly feed electricity without intermission to, for example, the seat 101, which permits various seat arrangements through sliding motion and rotation as illustrated in, for example, FIG. 7. In addition, the wire harness for a seat 1 causes the winding unit 20 to take up the excess length of the first routing member 10 to thereby be able to, for example, prevent noise caused by the first routing member 10 fluttering from occurring.

Specifically, in the wire harness for a seat 1, which has been described above, the stator 21 of the winding unit 20 unwinds and winds the first routing member 10 in the sliding direction L1 with the sliding motion of the seat 101. As a result, the wire harness for a seat 1 can achieve a configuration that properly takes up the excess length of the first routing member 10 corresponding to the sliding position of the seat 101 as described above.

The wire harness for a seat according to the embodiment of the present invention described above is not limited to the embodiment described above and various changes can be made without departing from the scope of the invention defined by the appended claims.

The sliding direction L1 of the seat 101, which has been described in the above embodiment as extending in the fore-aft direction X, is illustrative only and not limiting and may extend in the width direction Y. The first routing member 10, which has been described in the above embodiment as including the flat cable (FFC), is illustrative only and not limiting and may be formed from an ordinary electric wire.

The wire harness for a seat in the aspect of the present embodiment electrically connects the power source on the side of the vehicle floor with the electric component in the seat via the first routing member, the winding unit, and the second routing member to thereby be able to feed (supply) electricity from the power source to the electric component. In this case, the winding unit causes the stator to unwind and wind the first routing member with the sliding motion of the seat and also relays the electric connection between the first routing member and the second routing member through the rotor that rotates relatively to the stator with the rotation of the seat. Through the foregoing configurations, the winding unit can properly take up an excess length of the first routing member to correspond to the sliding position of the seat and permit rotation of the seat while maintaining a condition in which the first routing member is electrically connected with the second routing member. As a result, the wire harness for a seat achieves an effect of being able to properly feed electricity to the seat.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness for a seat, comprising:
a first routing member that has a first end portion connected electrically with a power source on a side of a vehicle floor;
a winding unit disposed at a rotational shaft of a seat disposed on the vehicle floor, the winding unit including a stator and a rotor, the stator being capable of sliding with the seat in a sliding direction and incapable of rotating integrally with the seat in a rotating direction about the rotational shaft of the seat and the stator being connected with a second end portion of the first routing member to thereby unwind and wind the first routing member as the seat slides, the rotor being capable of sliding with the seat in the sliding direction and capable of rotating integrally with the seat in the rotating direction about the rotational shaft; and
a second routing member disposed in the seat, the second routing member having a first end portion connected with the rotor and a second end portion connected electrically with an electric component disposed in the seat, wherein
the rotor rotates relatively to the stator with rotation of the seat and relays an electric connection between the first routing member connected with the stator and the second routing member connected with the rotor.

2. The wire harness for a seat according to claim 1, wherein
the stator unwinds and winds the first routing member in the sliding direction with sliding motion of the seat.
